(19) United States
(12) Patent Application Publication
(10) Pub. No.: US 2018/0219807 A1
(43) Pub. Date: Aug. 2, 2018

(54) SYSTEMS AND METHODS FOR PROVIDING AN AUTOMATED TECHNICAL SUPPORT ASSISTANT

(71) Applicant: JPMorgan Chase Bank, N.A., New York, NY (US)

(72) Inventors: Eric C. Thinguldstad, New Albany, OH (US); Lauren Ready, Westerville, OH (US); Jeffrey Dean Mathwig, Worthington, OH (US)

(21) Appl. No.: 15/885,326

(22) Filed: Jan. 31, 2018

Related U.S. Application Data
(60) Provisional application No. 62/452,792, filed on Jan. 31, 2017.

(51) Int. Cl. H04L 12/58; G06F 9/451; G06F 17/30; G06Q 10/10; G06F 15/18

(52) U.S. Cl. CPC H04L 51/02; G06F 9/453; G06F 15/18; G06Q 10/10; G06F 17/30654

(57) ABSTRACT

Systems and methods for providing an automated technical assistant agent are provided. In one embodiment, a method for providing an automated technical support agent may include: (1) receiving, from a computer application executed by electronic device, an electronic request to initiate an automated technical support agent; (2) communicating, to the electronic device, a first inquiry, and a plurality of first response options; (3) receiving, from the electronic device, a selection of one of the plurality of first response options; (4) determining a request for information based on the selected response option; (5) communicating, to the electronic device, the request for information; (6) receiving, from the electronic device, a response to the request for information; (7) determining, based on the selected first response option and the response to the request for information, a course of action; and (8) communicating the course of action to the electronic device.

### RELATED APPLICATIONS

The present application claims the benefit of U.S. Provisional Patent Application Ser. No. 62/452,792, filed Jan. 31, 2017, the disclosure of which is hereby incorporated, by reference, in its entirety.

### BACKGROUND OF THE INVENTION

### 1. Field of the Invention

The present disclosure generally relates to systems and methods for providing an automated technical support assistant.

### 2. Description of the Related Art

Information technology is a critical part of an organization's operation. Employees at large organizations rely on their IT department to address workstation, laptop, tablet, and phone issues, resulting in thousands of calls per month, with an average handle time of over ten minutes. This leads to long phone queues, and a loss in productivity.

### SUMMARY OF THE INVENTION

Systems and methods for providing an automated technical support assistant are disclosed. According to one embodiment, in an information processing apparatus, a method for providing an automated technical support agent may include: (1) receiving, from a computer application executed by electronic device, an electronic request to initiate an automated technical support agent; (2) communicating, to the electronic device, a first inquiry, and a plurality of first response options; (3) receiving, from the electronic device, a selection of one of the plurality of first response options; (4) determining a request for information based on the selected response option; (5) communicating, to the electronic device, the request for information; (6) receiving, from the electronic device, a response to the request for information; (7) determining, based on the selected first response option and the response to the request for information, a course of action; and (8) communicating the course of action to the electronic device.

In one embodiment, the course of action may be based on machine learning.

In one embodiment, the step of determining, based on the selected first response option and the response to the request for information, a course of action may include identifying, in a database, a prior issue associated with the selected first response option and the response to the request for information; and retrieving the course of action associated with the prior issue.

In one embodiment, the method may further include communicating the selected first response option and the response to the request for information to an agent for review.

In one embodiment, the method may further include receiving, from the electronic device, feedback on the course of action, and storing the feedback and the course of action in a database.

In one embodiment, the response to the request for information may include an image.

In one embodiment, the first inquiry, the plurality of first response options, and the request for information may be presented on the electronic device in a chat interface.

According to another embodiment, in an electronic device comprising at least one computer processor executing a computer application, a method for providing an automated technical support agent may include: (1) receiving, from a user, a request to initiate an automated technical support agent; (2) presenting, in a chat interface, a first inquiry, and a plurality of first response options; (3) receiving a selection of one of the plurality of first response options from the user; (4) communicating the selected first response options to a backend; (5) receiving, from the backend, a request for information based on the selected response option; (6) presenting, in the chat interface, the request for information; (7) receiving, from the user, a response to the request for information; (8) communicating the response to the request for information to the backend; (9) receiving, from the backend, a course of action; and (10) presenting the course of action in the chat interface.

In one embodiment, the course of action may be based on machine learning.

In one embodiment, the method may further include presenting, in the chat interface, a request for feedback regarding the course of action; receiving, from the user, the feedback; and communicating the feedback to the backend.

In one embodiment, the response to the request for information may include an image.

In one embodiment, the plurality of first response options may be related to technical problems. The technical problem may be with the electronic device, with a second electronic device, etc.

According to another embodiment, a system for providing an automated technical support agent may include an electronic device comprising at least one computer processor executing a computer application; and a backend comprising at least one computer processor in communication with the electronic device. The electronic device may receive from a user, a request to initiate an automated technical support agent, may present, in a chat interface, a first inquiry, and a plurality of first response options; may receive a selection of one of the plurality of first response options from the user; and may communicate the selected first response options to the backend. The backend may determine a request for information based on the selected response option and communicate to the electronic device the request for information. The electronic device may present, in the chat interface, the request for information; may receive, from the user, a response to the request for information; and may communicate the response to the request for information to the backend. The backend may determine, based on the selected first response option and the response to the request for information, a course of action; and may communicate the course of action to the electronic device. The electronic device may present the course of action in the chat interface.

In one embodiment, the course of action may be based on machine learning.

In one embodiment, the system may further include a database, and the electronic device may receive feedback on the course of action and communicates the feedback to the backend, and the backend stores the feedback and the course of action in a database.

In one embodiment, the response to the request for information may include an image.

In one embodiment, the system may further include a second electronic device, and the plurality of first response options are related to technical problems; and at one of the technical problems is with a second electronic device.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for providing an automated technical support agent according to one embodiment;

FIG. 2 depicts a method for providing an automated technical support agent according to one embodiment;

FIG. 3 depicts an exemplary captured screen image according to one embodiment;

FIGS. 4A, 4B, and 4C depict screenshots of an automated technical assistant agent according to one embodiment; and

FIG. 5 depicts a screenshot of an automated technical assistant agent according to one embodiment.

### DETAILED DESCRIPTION OF PREFERRED EMBODIMENTS

Systems and methods for providing an automated technical support agent are disclosed.

In embodiments, an automated technical assistant may be provided as a “chatbot” that may be used to help troubleshoot technical problems though, for example, a question and answer process. For example, a user, such as an employee, may be faced with a problem, such as a printer malfunction. After launching the chatbot, the chatbot may collect information, such as logs, user session information, and any other information that is necessary and/or desired, and may send to the collected information to one or more support teams with a ticket number (e.g., a tracking or other reference number). In one embodiment, the information collection may be fully automated, thereby reducing the time and effort needed from the user. In one embodiment, automated or semi-automated telephonic follow-up may be provided.

In embodiments, if the user has a question about, or is having difficulty with, a computer program that he or she is using, instead of calling the support team on the telephone, the user may initiate or open a chatbot technical assistance session for help. The chatbot may automatically “grab” a screenshot, or may request that the user take a screenshot, to understand where the user is having difficulty, and may offer assistance. For example, a user may be opening an account in a program and may be stuck at the second step in a process. The user may then open the chatbot, which may recognize, from the content of the screen, the program and the point at which the user is having difficulty. The chatbot may then provide troubleshooting, guidance, and/or solutions.

In one embodiment, the chatbot may access one or more database of solutions to provide the guidance, and may provide machine learning capabilities based on prior experiences.

In another embodiment, if the user's computer screen is frozen or nonresponsive, the user may launch the support chatbot from an application that may be executed on the user's mobile device. The user may take a picture or image of the screen using the mobile device, and may attach to the picture or image to the job ticket or request that the chatbot helps the user open. Depending on the issue, a ticket may be opened and the user may be contacted by phone, or the chatbot may offer troubleshooting and/or steps to resolve the issue.

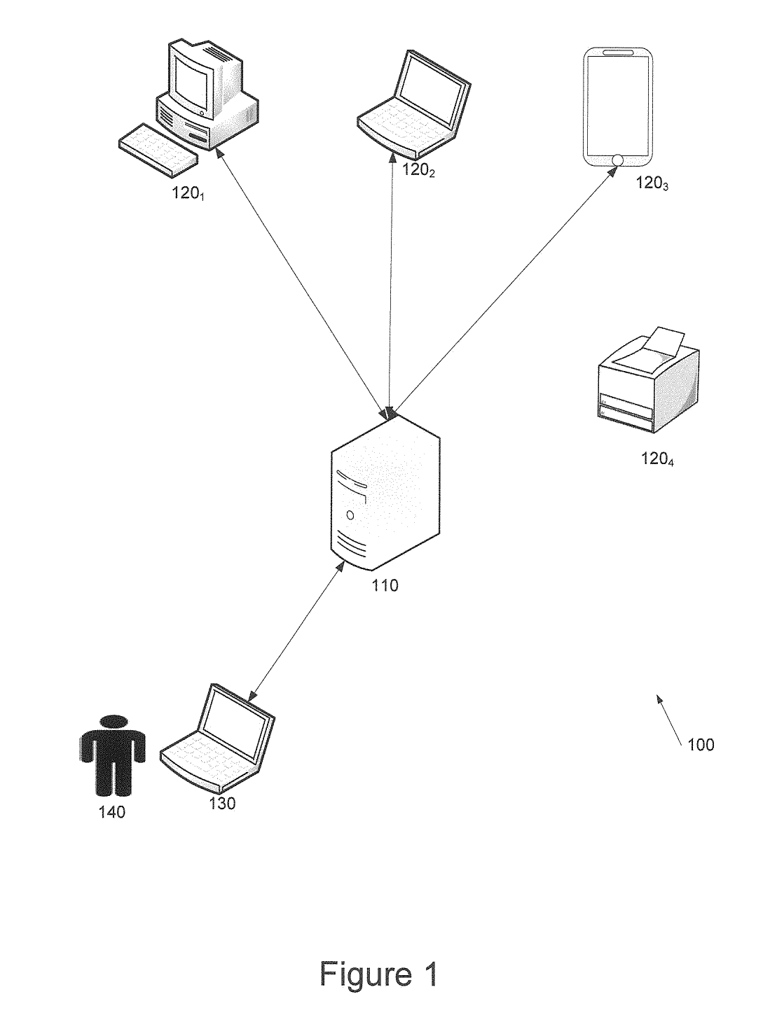

Referring to FIG. 1, a system for providing an automated technical assistant is provided according to one embodiment. System 100 may include a plurality of electronic devices (e.g., workstation 120₁, laptop 120₂, tablet computer/smart phone 120₃, printer 120₄, etc. Other devices, including Internet of Things (“IoT”) devices, monitors, printers, etc. may be included as is necessary and/or desired. Other examples of devices 120 include landline phones, security systems, cameras, robots, vaults, LAN connections, thermostats, or any other device that may need troubleshooting.

It should be noted that these electronic devices are exemplary only, greater or fewer, and different types/combinations of electronic devices may be used as is necessary and/or desired.

In one embodiment, the electronic devices may be networked with server 110, or they may be free-standing electronic devices.

Server 110 may host or execute one or more computer programs that may provide automated technical assistant services to the users of any of electronic devices 120. In one embodiment, technical assistant services may include chatbot services, automated troubleshooting, machine learning-based troubleshooting, service request preparation, etc.

In one embodiment, user 140 may interact with a service hosted by server 110 using electronic device 130, which may be any suitable electronic device. For example, electronic device may be a tablet computer, a smart phone, etc.

In one embodiment, electronic device 130 and electronic device 120 may be the same electronic device.

In one embodiment, electronic device 120 and/or electronic device 130 may execute a computer program or application that may interface with the service hosted by server 110. For example, device 120 and/or electronic device 130 may execute a computer program or application that executes a local instance of the chatbot interface, collects information, etc. and communicates that information to server 110.

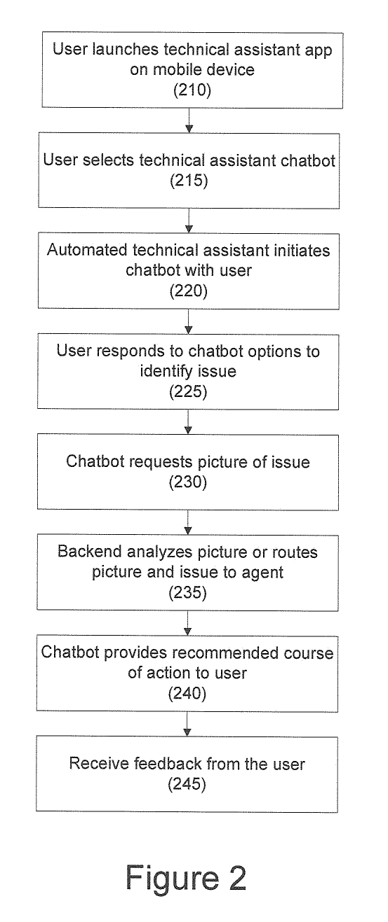

Referring to FIG. 2, a method for providing an automated technical assistant is provided according to one embodiment. In step 210, a user needing technical assistance may launch a technical assistant computer application (“app”) or program on the user's electronic device. In one embodiment, the electronic device may be a smartphone, tablet computer, etc.

In step 215, the user may be presented with technical assistance options, such as contact a live technical assistant, launch automated technical assistant (e.g., a chatbot), etc. Other options may be provided as is necessary and/or desired.

In step 220, the automated technical assistant may initiate a chatbot for interacting with the user. In one embodiment, the interaction may be presented in a manner similar to a text messaging (e.g., SMS) session. In one embodiment, the chatbot may ask a question, and provide a plurality of possible answers for the user to select among. For example, the chatbot may ask “Can I help you today?” and may identify “Hardware,” “Policy and Procedures,” and “Other” as fixed responses. In one embodiment, the chatbot may receive words or phrases from the user, and may use natural language processing to determine the meaning and identify the reason for the communication.

In step 225, the user may respond to the chatbot, and after the chatbot receives a response, the chatbot may ask one or more follow-up questions. For example, in the example above, after the user identifies “Hardware” as the issue, the chatbot may ask “What kind of hardware issue are you having?” and may provide options such as “Printer,” “Monitor,” and “Other” as options for the user to select.

In step 230, when the chatbot has reached a certain level in its decision tree, it may request that the user provide a picture of the issue. For example, the chatbot may request that the user take a picture or an image of a monitor, a serial number, settings, etc. The picture may be included as part of the chat conversation.

In one embodiment, the chatbot may categorize and/or prioritize issues based on the information received. In one embodiment the priority may be also be based on the number of instances (e.g., many similar instances may elevate the priority level for the issue).

In step 235, the backend may receive the data from the chatbot and may analyze the data for a solution. For example, the backend may analyze the picture to see if there is power to the device. As another example, the backend may use a serial number or model number for the equipment to identify troubleshooting steps. It may further verify software versions, confirm that software was delivered, etc.

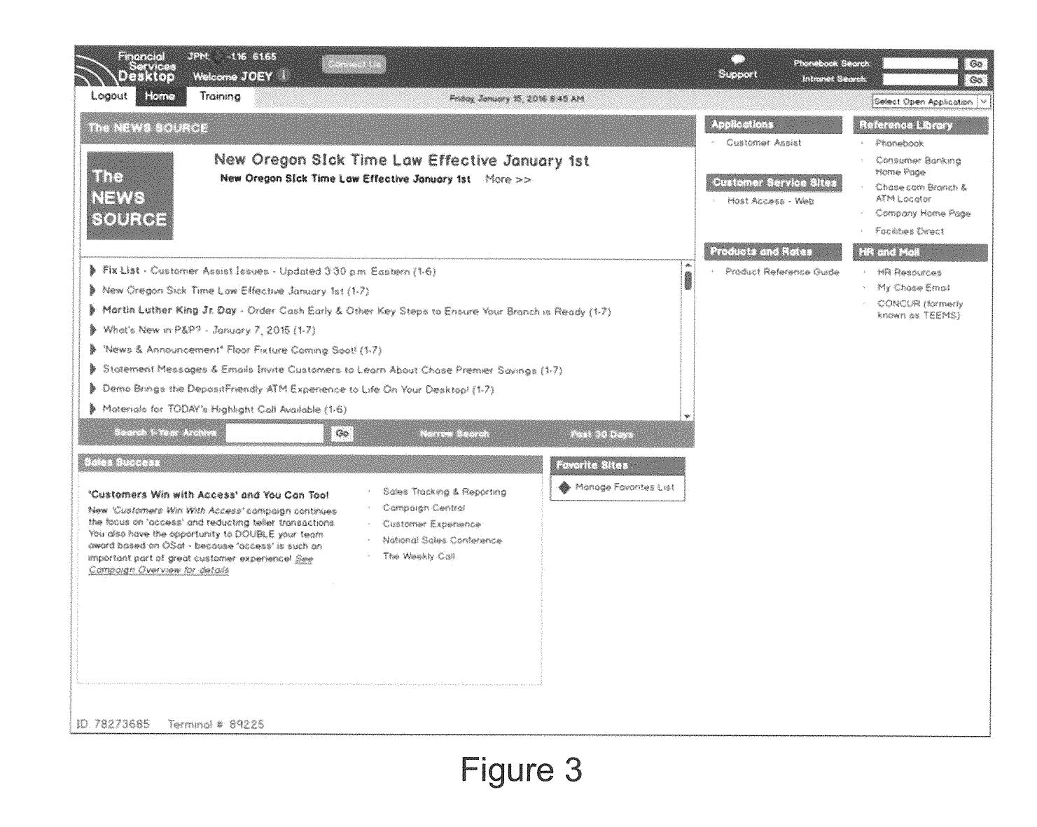

Referring to FIG. 3, an example of a picture or image that is captured by the user is provided. In one embodiment, application or backend may analyze the image, using pixel recognition to identify, for example, the person making the request, the open application, the page within the application, customer information, monitor type, workstation type, tablet type, terminal identifier, employee ID, rights to use the application, etc. The pixel information may be compared to a database of information (e.g., a machine-learning database) that can identify, for example, the normal screen that should be presented, whether the user is in a pilot that may have a different support team, whether this is related to a previous open ticket that has workarounds, an estimated resolution time, etc.

In one embodiment, if the backend cannot identify the issue, the backend may send the data to a human agent for handling. In one embodiment, a new ticket, or job request, may be created with the information (e.g., chat transcript and any other data collected (e.g., pictures, serial numbers, etc.), and a remote connection with the affected workstation or device may be established. This connection may be used to collect any additional data that may update the machine-based (e.g., artificial intelligence) rules.

In step 240, the chatbot may provide the user with a course of action to address the issue. In one embodiment, the course of action may be determine from a troubleshooting procedure, based on machine learning, or it may be provided by a human agent.

In one embodiment, artificial intelligence may be used to identify patterns and correlations, and to identify a course of action based on similar issues and the course(s) of action taken.

In one embodiment, the course of action may include step by step procedures, recovery information, etc.

In step 245, the user may provide feedback (e.g., “it worked,” “it did not work,” “need further assistance,” etc.) to the chatbot. In one embodiment, the feedback may be used in a machine-learning process to address future issues. In one embodiment, if the user requires further assistance, the chatbot conversation maybe transferred along with the collected information, course(s) of action taken, the results, etc. to a technician who will contact the user.

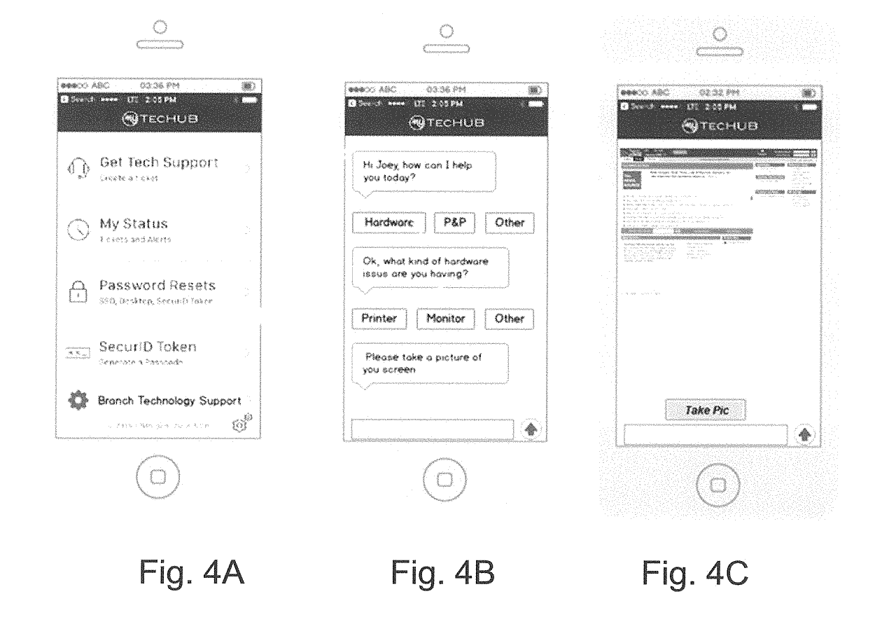

Example screenshots of a chatbot executed on a mobile device according to one embodiment are provided below as FIGS. 4A, 4B, and 4C.

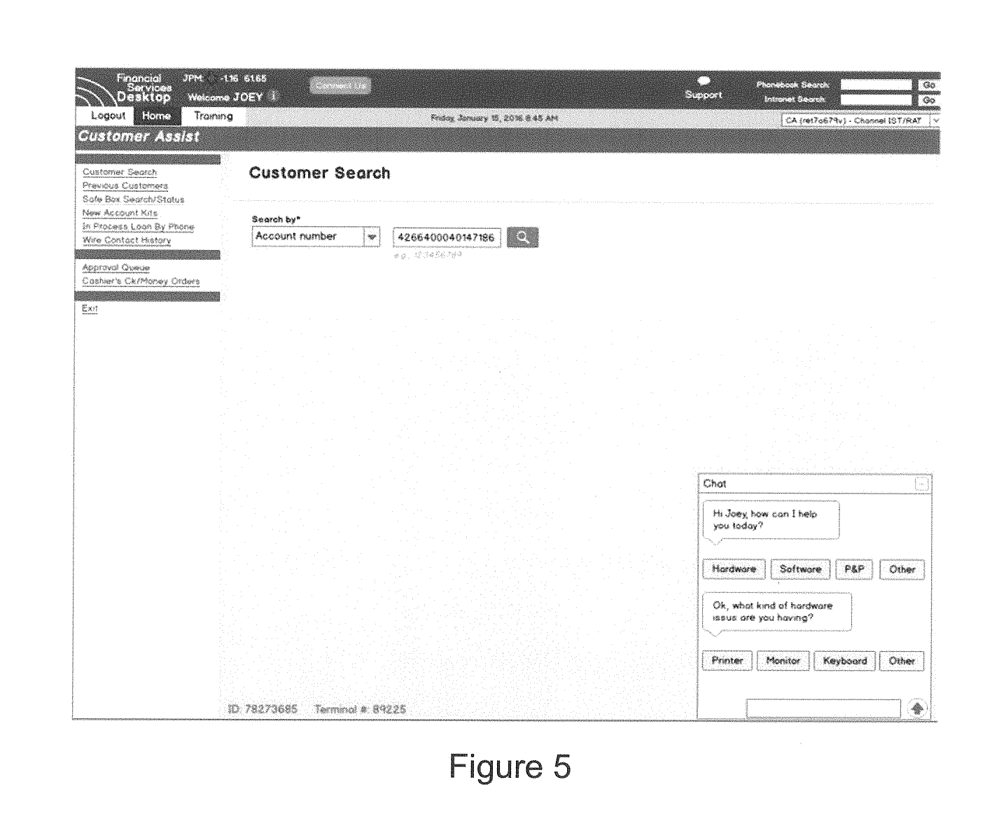

In another embodiment, the chatbot may be provided on a desktop computer. For example, an exemplary screenshot of a desktop-based chatbot is provided in FIG. 5.

In one embodiment, the chatbot application may have multiple launch points so that the user may access this support if one of his or her devices is inoperable. In one embodiment, the user's devices may be associated such that that the problem could be addressed from any of those devices. For example, to address a thermostat issue, the user may launch the technical assistance application from a controller associated with the thermostat.

The disclosure of U.S. Patent Application Ser. No. 62/546,717 is hereby incorporated by reference in its entirety.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, intranets, extranets, LANs, Ethernets, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for providing an automated technical support agent, comprising:
in an information processing apparatus comprising at least one computer processor:
receiving, from a computer application executed by electronic device, an electronic request to initiate an automated technical support agent;
communicating, to the electronic device, a first inquiry, and a plurality of first response options;
receiving, from the electronic device, a selection of one of the plurality of first response options;
determining a request for information based on the selected response option;
communicating, to the electronic device, the request for information;
receiving, from the electronic device, a response to the request for information;
determining, based on the selected first response option and the response to the request for information, a course of action; and
communicating the course of action to the electronic device.

2. The method of claim 1, wherein the course of action is based on machine learning.

3. The method of claim 2, wherein the step of determining, based on the selected first response option and the response to the request for information, a course of action comprises:
identifying, in a database, a prior issue associated with the selected first response option and the response to the request for information; and
retrieving the course of action associated with the prior issue.

4. The method of claim 1, further comprising:
communicating the selected first response option and the response to the request for information to an agent for review.

5. The method of claim 1, further comprising:
receiving, from the electronic device, feedback on the course of action.

6. The method of claim 5, further comprising:
storing the feedback and the course of action in a database.

7. The method of claim 1, wherein the response to the request for information comprises an image.

8. The method of claim 1, wherein the first inquiry, the plurality of first response options, and the request for information are presented on the electronic device in a chat interface.

9. A method for providing an automated technical support agent, comprising:
in an electronic device comprising at least one computer processor executing a computer application:
receiving, from a user, a request to initiate an automated technical support agent;
presenting, in a chat interface, a first inquiry, and a plurality of first response options;
receiving a selection of one of the plurality of first response options from the user;
communicating the selected first response options to a backend;
receiving, from the backend, a request for information based on the selected response option;
presenting, in the chat interface, the request for information;
receiving, from the user, a response to the request for information;
communicating the response to the request for information to the backend;
receiving, from the backend, a course of action; and
presenting the course of action in the chat interface.

10. The method of claim 9, wherein the course of action is based on machine learning.

11. The method of claim 9, further comprising:
presenting, in the chat interface, a request for feedback regarding the course of action;
receiving, from the user, the feedback; and
communicating the feedback to the backend.

12. The method of claim 9, wherein the response to the request for information comprises an image.

13. The method of claim 9, wherein the plurality of first response options are related to technical problems.

14. The method of claim 13, wherein the technical problem is with the electronic device.

15. The method of claim 13, wherein the technical problem is with a second electronic device.

16. A system for providing an automated technical support agent, comprising:
an electronic device comprising at least one computer processor executing a computer application; and
a backend comprising at least one computer processor in communication with the electronic device;
wherein
the electronic device receives from a user, a request to initiate an automated technical support agent;
the electronic device presents, in a chat interface, a first inquiry, and a plurality of first response options;
the electronic device receives a selection of one of the plurality of first response options from the user;
the electronic device communicates the selected first response options to the backend;
the backend determines a request for information based on the selected response option;
the backend communicates to the electronic device the request for information;
the electronic device presents, in the chat interface, the request for information;
the electronic device receives, from the user, a response to the request for information;
the electronic device communicates the response to the request for information to the backend;
the backend determines, based on the selected first response option and the response to the request for information, a course of action;
the backend communicates the course of action to the electronic device; and
the electronic device presents the course of action in the chat interface.

17. The system of claim 16, wherein the course of action is based on machine learning.

18. The system of claim 16, further comprising a database;
wherein the electronic device receives feedback on the course of action and communicates the feedback to the backend, and the backend stores the feedback and the course of action in a database.

19. The system of claim 16, wherein the response to the request for information comprises an image.

20. The system of claim 16, further comprising a second electronic device;
wherein the plurality of first response options are related to technical problems; and
wherein at least one of the technical problems is with a second electronic device.
